(19) United States
(12) Patent Application Publication
(10) Pub. No.: US 2024/0143160 A1
(43) Pub. Date: May 2, 2024

(54) ELECTRONIC WHITEBOARD SYSTEM AND OPERATION METHOD THEREOF

(71) Applicant: Optoma Corporation, New Taipei City (TW)

(72) Inventor: Wen-Tai Wang, New Taipei City (TW)

(73) Assignee: Optoma Corporation, New Taipei City (TW)

(21) Appl. No.: 17/976,892

(22) Filed: Oct. 31, 2022

(51) Int. Cl. G06F 3/04883; G06V 30/19

(52) U.S. Cl. CPC G06F 3/04883; G06V 30/19127

(57) ABSTRACT

An electronic whiteboard system and an operation method thereof are provided. The electronic whiteboard system includes an electronic device and a display. The electronic device includes a whiteboard module. The whiteboard module is configured to perform a writing operation. The whiteboard module is configured to generate a writing data according to a writing event, and recognize the writing data to determine a text information, and determine a corresponding computer text according to the text information. The display is connected to the whiteboard module. The display is configured to display the corresponding computer text or a preset writing picture according to the corresponding computer text.

### BACKGROUND

### Technical Field

The invention relates to a system, in particular, to an electronic whiteboard system and an operation method thereof.

### Description of Related Art

In general, when a user writes on the electronic device (such as cloud electronic whiteboard), the user may use a mouse or a stylus to simulate the writing action of the pen to write on the electronic device. However, because it is difficult to control the mouse or the stylus to write the texts (i.e. words or characters), the texts written by the mouse or the stylus are of poor quality.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The invention is directed to an electronic whiteboard system and an operation method thereof, which can provide a writing function of a cloud electronic whiteboard.

Other objects and advantages of the invention may be further illustrated by the technical features broadly embodied and described as follows.

In order to achieve one or a portion of or all of the objects or other objects, an embodiment of the invention provides an electronic whiteboard system. The electronic whiteboard system includes an electronic device and a display. The electronic device includes a whiteboard module. The whiteboard module is configured to perform a writing operation. The whiteboard module is configured to generate a writing data according to a writing event, and recognize the writing data to determine a text information, and determine a corresponding computer text according to the text information. The display is connected to the whiteboard module. The display is configured to display the corresponding computer text or a preset writing picture according to the corresponding computer text.

In the embodiment of the invention, the whiteboard module is configured to digitize a writing track of the writing event to generate a digitized image of the writing data.

In the embodiment of the invention, the digitized image is a binary image.

In the embodiment of the invention, the whiteboard module is configured to perform feature extraction on the binary image, and generate a plurality of feature parameters.

In the embodiment of the invention, the whiteboard module includes a neural network model. The neural network model is configured to recognize the binary image according to the plurality of feature parameters and output a recognizing result. The whiteboard module may generate at least one font model according to the recognizing result, and the preset writing picture is correspond to one of the at least one the font model.

In the embodiment of the invention, the plurality of feature parameters comprises at least one of a font position, a font size, a font slant, a font height and a font width.

In the embodiment of the invention, the corresponding computer text is an alphanumeric character.

In the embodiment of the invention, the electronic device further includes an input module. The input module is connected to the whiteboard module, and configured to generate an operation command. The whiteboard module is configured to determine that the corresponding computer text corresponds to the preset writing picture according the operation command. The input module comprises at least one of a button of a keyboard and a mouse.

In the embodiment of the invention, the operation command includes controlling the display to show the corresponding computer text or the preset writing picture.

In the embodiment of the invention, the writing event includes a writing track, and the electronic device further includes an input module. An input module, connected to the whiteboard module, and configured to generate the writing track. The input module includes at least one of a mouse, a stylus and a touch panel.

In order to achieve one or a portion of or all of the objects or other objects, an embodiment of the invention provides an operation method of an electronic whiteboard system. The operation method includes the following steps: performing a writing operation by a whiteboard module; generating a writing data according to a writing event; recognizing the writing data to determine a text information; determining a corresponding computer text according to the text information; and display the corresponding computer text or a preset writing picture according to the corresponding computer text by a display.

In the embodiment of the invention, the step of generating the writing data includes: digitizing a writing track of the writing event to generate a digitized image of the writing data.

In the embodiment of the invention, the digitized image is a binarized image.

In the embodiment of the invention, the step of recognizing the writing data includes: performing feature extraction on the binarized image; and generating a plurality of feature parameters.

In the embodiment of the invention, the step of determining the corresponding computer text includes: recognizing the binary image according to the plurality of feature parameters and output a recognizing result by a neural network model; and generating at least one font model according to the recognizing result by the whiteboard module, wherein the preset writing picture is correspond to one of the at least one the font model.

In the embodiment of the invention, the plurality of feature parameters comprises at least one of a font position, a font size, a font slant, a font height and a font width.

In the embodiment of the invention, the corresponding computer text is an alphanumeric character.

In the embodiment of the invention, the operation method further includes: generating an operation command by an input module, and determining the corresponding computer text corresponds to the preset writing picture according the operation command by the whiteboard module.

In the embodiment of the invention, the operation command includes controlling the display to show the corresponding computer text or the preset writing picture.

In the embodiment of the invention, the writing event includes a writing track.

Based on the above description, the electronic whiteboard system and the operation method thereof of the invention may show the corresponding computer text or the preset writing picture by the display according to the writing track.

To make the aforementioned more comprehensible, several embodiments accompanied with drawings are described in detail as follows.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of an electronic whiteboard system according to an embodiment of the invention.

FIG. 2 is a flowchart of an operation method of the electronic whiteboard system according to an embodiment of the invention.

FIG. 3 is a schematic diagram of generating a corresponding computer text and a preset writing picture according to an embodiment of the invention.

FIG. 4 is a schematic diagram of establishing at least one font model according to an embodiment of the invention.

FIG. 5 is a schematic diagram of recognizing the writing track according to an embodiment of the invention.

FIG. 6 is a schematic diagram of showing the corresponding computer text or the preset writing picture according to an embodiment of the invention.

### DESCRIPTION OF THE EMBODIMENTS

It is to be understood that other embodiment may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

The above and other technical contents, features, and effects of the invention will be clearly presented in the following detailed description of a preferred embodiment with reference to the accompanying drawings. Directional terminology, such as “top,” “bottom,” “left,” “right,” “front,” “back,” etc., mentioned in the following embodiments is used with reference to the orientation of the Figure(s) being described and are not intended to be limiting of the invention.

In order to make the content of the invention more comprehensible, the following embodiments are specifically cited as examples on which the invention may indeed be implemented. In addition, wherever possible, elements/components/steps with the same reference numbers in the drawings and embodiments represent the same or similar components.

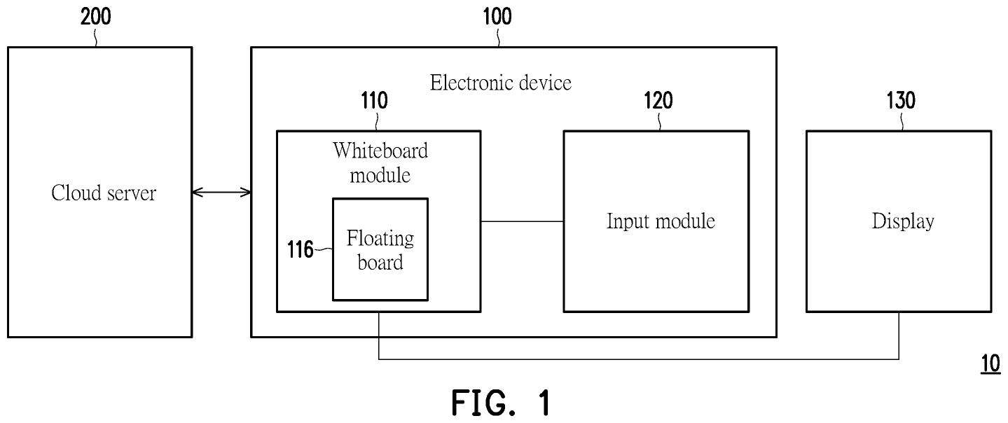

FIG. 1 is a schematic diagram of an electronic whiteboard system according to an embodiment of the invention. Referring to FIG. 1, the electronic whiteboard system 10 includes an electronic device 100 and a display 130. The electronic device 100 includes a whiteboard module 110 and an input module 120. The display 130 is connected to the whiteboard module 110. The whiteboard module 110 includes a floating board 116, and the floating board 116 may be a function menu. The function menu may include icons corresponding to the functions that the user may operate. In the embodiment of the invention, the electronic device 100 may be an interactive flat panel (IFP), an electronic whiteboard with networking capability, a personal computer (PC), a tablet computer, a smart phone or similar electronic device, respectively, and may also include, for example, a processor, a storage device, a display device and a communication interface. The whiteboard module 110 is connected to the input module 120. The whiteboard module 110 may be configured to execute a whiteboard web program to perform a cloud electronic whiteboard. The whiteboard module 110 may execute the floating board 116 on a whiteboard web, and the display 130 may display an operation interface including cloud electronic whiteboard, so that the user may execute a writing operation on cloud electronic whiteboard through operating the floating board 116 by the input module 120. The input module 120 includes at least one of a mouse and a stylus, and the input module 120 is configured to generate a writing track according to the operation of the input module 120 by controlling of the user, and may correspondingly generate an operation command of the writing operation.

In the embodiment of the invention, in a process of the writing operation, the user may operate the input module 120 to write on the cloud electronic whiteboard, and the whiteboard module 110 may recognize the writing track, and may determine a corresponding computer text. Moreover, the whiteboard module 110 may further show the corresponding computer text or a preset writing picture corresponding to the corresponding computer text by the display 130 according to the operation command provided by the input module 120. Therefore, the electronic whiteboard system 10 may transform the writing track to the corresponding computer text and the preset writing picture, may conveniently allow the user to choose to show the corresponding computer text or the preset writing picture on the cloud electronic whiteboard displayed by the display 130.

In the embodiment of the invention, the electronic device 100 may further includes a processor and a storage device. The processor is coupled to the storage device. The processor may include, for example, a central processing unit (CPU) having an image data processing function, or other programmable general-purpose or special-purpose microprocessors, an image processing units (IPU), a graphics processing unit (GPU), a digital signal processor (DSP), an application specific integrated circuits (ASIC), a programmable logic device (PLD), other similar arithmetic circuits, or a combination of these circuits. The storage device may include, for example, a non-volatile memory. The storage device may store the programs and algorithms of the whiteboard module 110 for the processor to read and execute the programs and algorithms of the whiteboard module 110, so as to realize the writing operation or the related operations, processes and functions of the cloud electronic whiteboard of the present invention. The display 130 may be a projector, a liquid crystal display, screen, but the invention is not limited thereto. In one embodiment of the invention, the display 130 may be integrated into the electronic device 100 or may be a peripheral device of the electronic device 100.

In the embodiment of the invention, the electronic device 100 may further include a communication interface (or a data transmission module), and the electronic device 100 may be connected to the Internet or other network systems through the communication interface, so as to further connect to the cloud server 200. The communication interface is an interface capable of connecting the Internet, such as a circuit or a device connecting to the Internet by wireless (Wi-Fi device) or cable. In one embodiment of the invention, the electronic device 100 may further include a signal conversion module (not shown in figure), and the signal conversion module may be configured to receive and convert user's operation signal generated by editing on the cloud electronic whiteboard.

In the embodiment of the invention, the electronic whiteboard system 10 may be a multi-user collaboration system. The electronic whiteboard system 10 may be connected to a plurality of electronic devices, and the electronic devices may be operated by multiple users, respectively. The electronic devices may be implemented as electronic device 100 of FIG. 1, respectively. The cloud server 200 may be configured to provide a cloud electronic whiteboard function. The cloud server 200 may be disposed in the company capable of providing the service. The users may respectively execute the whiteboard web program on each of the electronic devices to perform related editing operations on the cloud electronic whiteboard. In one embodiment of the invention, the cloud server 200 may be configured as a collaboration hub to collect a plurality of edit information provided by the users performing collaborative editing of the cloud electronic whiteboard on the electronic devices, respectively. The cloud server 200 may process the edit information, so that the web application programs respectively executed by the electronic devices may display the collaborative editing result of the cloud electronic whiteboard by the displays respectively connected to the electronic devices. The cloud electronic whiteboard means that the users may display the image and related application tools (such as brushes, colors, etc.) like a physical electronic whiteboard on the electronic device 100 through the web application displayed by the displays, and the users may perform actions such as drawing, moving objects or sharing files on the image of the electronic device 100. The users may jointly edit on a common virtual whiteboard, and the users may view the same image of the cloud electronic whiteboard through the displays.

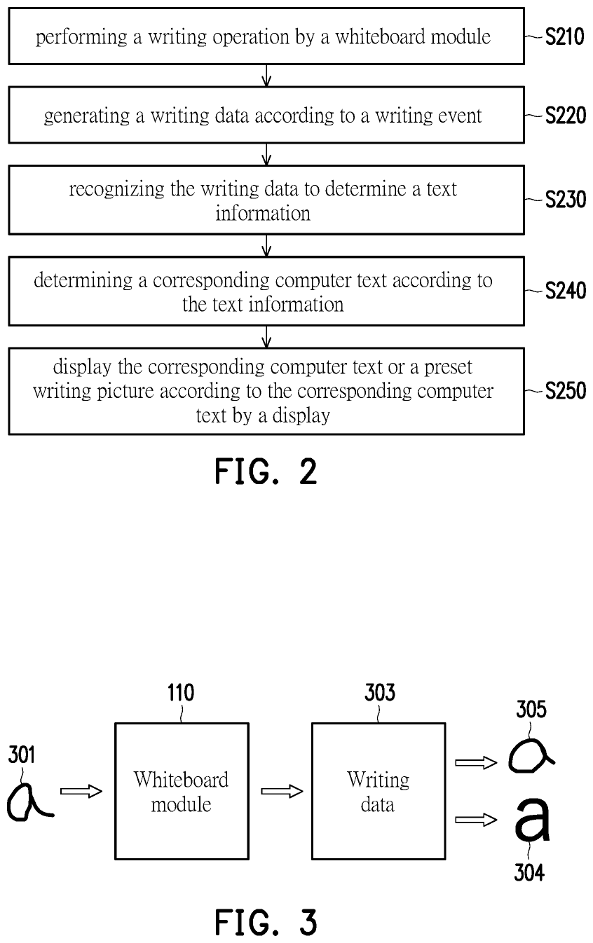

FIG. 2 is a flowchart of an operation method of the electronic whiteboard system according to an embodiment of the invention. FIG. 3 is a schematic diagram of generating a corresponding computer text and a preset writing picture according to an embodiment of the invention. Referring to FIG. 1 to FIG. 3, the electronic device 100 may execute the flowing steps. In step S210, the whiteboard module 110 may perform the writing operation. The user may operate the input module 120 to operate the floating board 116 to perform the writing operation on the cloud electronic whiteboard displayed by the display 130. The user may perform a writing event to generate the writing track 301 by controlling the input module 120. In step S220, the whiteboard module 110 may generate a writing data 303 corresponding to a corresponding computer text 304 according to the writing event. Specifically, the whiteboard module 110 further includes related recognition modules or data processing modules configured to generate the writing data 303 corresponding to the corresponding computer text 304 according to the writing track 301 (The following embodiments will further illustrate the related modules in the whiteboard module 110). In the embodiment of the invention, the writing data 303 may include the following data structure in table 1, but the invention is not limited thereto. In step S230, the whiteboard module 110 may recognize the writing data 303 to determine a text information. In the embodiment of the invention, the text information may be “hyperinfo:“a”” in the data structure of the writing data 303. The text information is represented a recognizing result of the writing track 301 by the whiteboard module 110.

TABLE 1

```
{ application: ‘Creative Board Web’,
  create_datetime: ‘2022-04-24T01:22:31’
  wbid: ‘wbNXs1c,
  accountid: ‘9f336b3ad380’,
  objectid: ‘WHW00123’,
  objecttype: “WebHandWrite”,
  objectImage: “HWimage/”,
  hyperInfo:“a”
  }
```

In step S240, the whiteboard module 110 may determine a corresponding computer text 304 according to the text information. In the embodiment of the invention, the corresponding computer text 304 may be, for example, an alphanumeric character. The alphanumeric character may be, for example, an ASCII character. In step S250, the whiteboard module 110 may show the corresponding computer text 304 or a preset writing picture 305 according to the corresponding computer text by the display 130. In the embodiment of the invention, the preset writing picture 305 may be a special personal handwriting.

Specifically, after the user completes the writing of the writing track 301, the user may operate the input module 120 to generate an operation command, so that the whiteboard module 110 may determine that the corresponding computer text 304 corresponds to the preset writing picture 305 according the operation command, and to select to show the corresponding computer text 304 or the preset writing picture 305 on the cloud electronic whiteboard displayed on the display 130. The input module 120 may include at least one of a button of a keyboard, a mouse and a stylus. For example, the user may operate by, for example, a button of the mouse, a button of the keyboard, or the stylus to generate the operation command. Therefore, the electronic whiteboard system 10 may transform the writing track 301 to the corresponding computer text 304 and the preset writing picture 305, may conveniently allow the user to choose to show the corresponding computer text 304 or the preset writing picture 305 on the cloud electronic whiteboard displayed by the display 130.

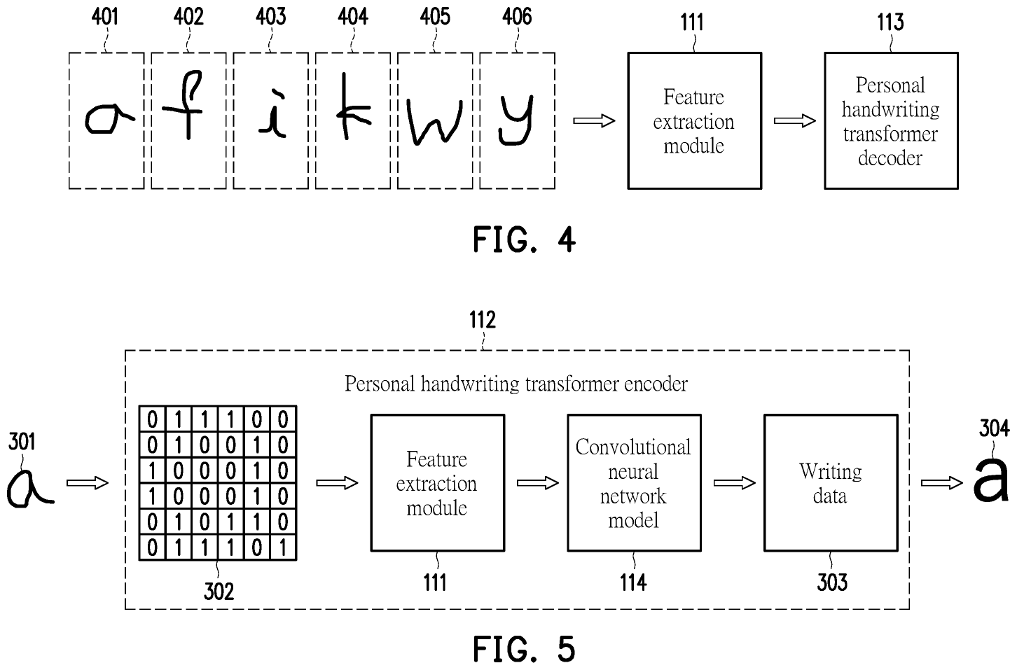

FIG. 4 is a schematic diagram of establishing at least one font model according to an embodiment of the invention. Referring to FIG. 1 and FIG. 4, in the embodiment of the invention, the whiteboard module 110 may further include a feature extraction module 111 and a personal handwriting transformer decoder 113. The user may previously operate the input module 120 to write a plurality of writing tracks 401 to 406 corresponding to a plurality of reference handwritings on the cloud electronic whiteboard. The writing tracks 401 to 406 may include text, number, characters, patterns and lines. Then the whiteboard module 110 may execute the feature extraction module 111 to perform feature extraction on the writing tracks 401 to 406, and generate a plurality of feature parameters corresponding to the writing tracks 401 to 406. Thus, the whiteboard module 110 may input the feature parameters corresponding to the writing tracks 401 to 406 to the personal handwriting transformer decoder 113 to establish at least one font model. In one embodiment of the invention, the personal handwriting transformer decoder 113 may establish a plurality of font models corresponding to different special personal handwriting. In the embodiment of the invention, the feature parameters may include at least one of a font position, a font size, a font slant, a font height and a font width. Specifically, the font position of the writing tracks 401 to 406 may be located at the center, left, right, top or bottom of reference coordinates. The font size of the writing tracks 401 to 406 may be large, medium, small or number point. The font slant of the writing tracks 401 to 406 may be −30 degree to 30 degree. The font height of the writing tracks 401 to 406 may be the height on the reference coordinates. The font width of the writing tracks 401 to 406 may be the width on the reference coordinates. In addition, a set of the reference handwritings in the embodiment may include six reference handwritings, but the invention is not limited thereto. And one font model established by the whiteboard module 110 corresponds to one set of the reference handwritings. Therefore, the electronic whiteboard system 10 may establish each person's special personal handwriting. When the writing track 301 generated by the input module 120 is recognized, the whiteboard module 110 may generate the corresponding computer text 304, the user may operate the button of the input module 120, and the whiteboard module 110 may generate the corresponding personal preset writing picture 305 according to the reference handwritings.

FIG. 5 is a schematic diagram of recognizing the writing track according to an embodiment of the invention. Referring to FIG. 1, FIG. 4 and FIG. 5, in the embodiment of the invention, the whiteboard module 110 may further include a personal handwriting transformer encoder 112, and the personal handwriting transformer encoder 112 may include the feature extraction module 111 and a neural network model 114. The whiteboard module 110 may extract features of handwriting through the neural network model 114. Then, the user may previously operate the input module 120 to write the writing track 301 corresponding to a formal writing on the cloud electronic whiteboard, and the whiteboard module 110 may execute the personal handwriting transformer encoder 112 to digitize the writing track 301 of the writing event to generate a digitized image 302. In the embodiment of the invention, the writing track 301 may be a writing text, and the digitized image 302 may be a binary image. Then, the whiteboard module 110 may execute the feature extraction module 111 to perform feature extraction on the digitized image 302, and generate a plurality of feature parameters corresponding to the digitized image 302. For example, the feature extraction module 111 of the whiteboard module 110 may extract the horizontal and vertical features of the digitized image 302 through convolution kernels or feature filters. In the embodiment of the invention, the feature parameters may include at least one of a font position, a font size, a font slant, a font height and a font width. Thus, the whiteboard module 110 may input the feature parameters corresponding to the digitized image 302 to the neural network model 114, so that the neural network model 114 may output a recognizing result, for example, the recognizing result in the embodiment is a text “a”. Then the whiteboard module 110 may generate the writing data 303 according to the recognizing result, and determine the corresponding computer text 304 according to the writing data 303.

In the embodiment of the invention, the neural network model 114 may be pre-trained, so as to capable of recognizing the digitized image 302 according to the feature parameters corresponding to the digitized image 302. In the embodiment of the invention, the neural network model 114 may be, for example, a convolutional neural network (CNN) model. Specifically, Hidden Layer of the convolutional neural network (CNN) model is configured to output the recognizing result. The programs of the feature extraction module 111 and the neural network model 114 may be stored in the storage device, and the processor may read and execute the programs of the feature extraction module 111 and the neural network model 114.

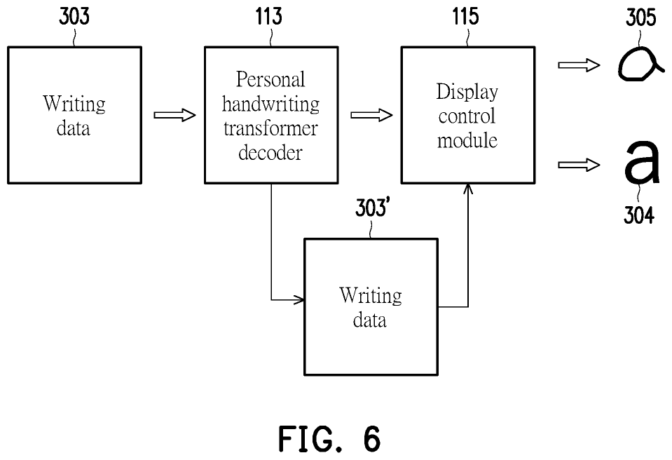

FIG. 6 is a schematic diagram of showing the corresponding computer text or the preset writing picture according to an embodiment of the invention. Referring to FIG. 1 and FIGS. 4 to FIG. 6, in the embodiment of the invention, the whiteboard module 110 may further include a display control module 115. The whiteboard module 110 may input the writing data 303 into the personal handwriting transformer decoder 113, and the personal handwriting transformer decoder 113 may generate another writing data 303′ corresponding to the preset writing picture 305 according to the at least one pre-established font model. The preset writing picture 305 is correspond to one of the at least one pre-established font model. In the embodiment of the invention, the writing data 303′ may include the following data structure in table 2, but the invention is not limited thereto. In the embodiment of the invention, the text information of the font of the preset writing picture 305 may be “PersonImage “PHWImage/”” in the data structure of the writing data 303′.

TABLE 2

```
{ application: ‘Creative Board Web’,
create_datetime: ‘2022-04-24T01:22:31’
wbid: ‘wbNXs1c,
  accountid: ‘9f336b3ad380’,
  bjectid: ‘WHW00123’,
  objecttype: “WebHandWrite”,
  objectImage: “HWimage/”,
  hyperInfo:“a”
  PersonImage: “PHWImage/”
  }
```

In the embodiment of the invention, the display control module 115 may select one of the writing data 303 and the writing data 303′ according to the operation command. The user may operate the button of the input module 120 to generate the operation command, so that the display control module 115 may control the display 130 to show the corresponding computer text 304 or the preset writing picture 305 in the cloud electronic whiteboard displayed on the display 130 based on at least one of the writing data 303 and the writing data 303′ and according to the operation command. The programs of the display control module 115 may be stored in the storage device, and the processor may read and execute the programs of the display control module 115. In one embodiment of the invention, the corresponding computer text 304 and the preset writing picture 305 may be switched to each other according to the operation command. For example, the whiteboard module 110 displays the corresponding computer text 304 at first, and then the whiteboard module 110 may be changed to display the preset writing picture 305 according to the operation command. Therefore, the user may quickly switch and decide the content displayed on the cloud electronic whiteboard through input module 120.

In summary, the electronic whiteboard system and the operation method thereof of the invention may recognize the writing track to determine the corresponding computer text, and may further generate the preset writing picture corresponding to the corresponding computer text. Moreover, the electronic whiteboard system may display the corresponding computer text or the preset writing picture according to the operation command from the user. Thus, the electronic whiteboard system and the operation method thereof of the invention may conveniently allow the user to choose to show the corresponding computer text or the preset writing picture on the cloud electronic whiteboard displayed by the display. The electronic whiteboard system may generate the writing track with personalized writing effect on the cloud electronic whiteboard, so that the user may conveniently generate font-specific texts (such as the electronic signature).

It will be apparent to those skilled in the art that various modifications and variations can be made to the disclosed embodiments without departing from the scope or spirit of the invention. In view of the foregoing, it is intended that the invention covers modifications and variations provided they fall within the scope of the following claims and their equivalents. Moreover, any embodiment of or the claims of the invention is unnecessary to implement all advantages or features disclosed by the invention. In addition, the abstract and the name of the invention are only used to assist patent searching, and are not used to limit a claim range of the invention.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. An electronic whiteboard system, comprising:
a storage device, configured to store at least one program;
a display device, configured to display a cloud electronic whiteboard; and
at least one processor, communicatively connecting with the storage device and the display device, configured to execute the at least one program for performing the cloud electronic whiteboard, and wherein
the at least one processor is configured to receive at least one writing track of a writing text on the cloud electronic whiteboard by a writing operation, and
the display device is configured to selectively display one of a computer text corresponding to the writing text and a personal handwriting text corresponding to the writing text on the cloud electronic whiteboard by an operation command, and wherein the writing text, the computer text and the personal handwriting text are different from each other.

2. The electronic whiteboard system according to claim 1, wherein the at least one processor is configured to digitize the at least one writing track of the writing text to generate a digitized image of the at least one writing track of the writing text.

3. The electronic whiteboard system according to claim 2, wherein the digitized image is a binary image.

4. The electronic whiteboard system according to claim 2, wherein the at least one processor is configured to perform a feature extraction on a binary image, and generate a plurality of feature parameters.

5. The electronic whiteboard system according to claim 4, wherein the at least one processor is configured to execute a neural network model, the neural network model is configured to recognize the binary image according to the plurality of feature parameters and output a recognizing result, and wherein the at least one processor is configured to generate at least one font model according to the recognizing result, and the personal handwriting text corresponds to one of the at least one the font model.

6. The electronic whiteboard system according to claim 4, wherein the plurality of feature parameters comprise at least one of a font position, a font size, a font slant, a font height and a font width.

7. The electronic whiteboard system according to claim 1, wherein the computer text is an alphanumeric character.

8. The electronic whiteboard system according to claim 1, wherein further comprising:
an input module, communicatively connected to the at least one processor, configured to generate the operation command,
wherein the input module comprises at least one of a button of a keyboard, a stylus, a touch panel and a mouse.

9. (canceled)

10. (canceled)

11. An operation method of an electronic whiteboard system, the electronic whiteboard system comprising a storage device, a display device and at least one processor, the operation method comprising:
displaying a cloud electronic whiteboard on the display device;
performing a writing operation on the display device;
receiving, by the at least one processor, at least one writing track of a writing text on the cloud electronic whiteboard by a writing operation;
receiving, by the at least one processor, an operation command; and
selectively displaying on the display device, by the at least one processor, one of a computer text corresponding to the writing text and a personal handwriting text corresponding to the writing text on the cloud electronic whiteboard by the operation command, and wherein the writing text, the computer text and the personal handwriting text are different from each other.

12. The operation method according to claim 11, further comprising:
digitizing, by the at least one processor, the at least one writing track of the writing text; and
generating, by the at least one processor, a digitized image of the writing data.

13. The operation method according to claim 12, wherein the digitized image is a binary image.

14. The operation method according to claim 21, wherein the step of recognizing the writing data comprises:
performing, by the at least one processor, a feature extraction on a binary image; and
generating, by the at least one processor, a plurality of feature parameters.

15. The operation method according to claim 14, further comprising:
recognizing, by the at least one processor, the binary image according to the plurality of feature parameters and output a recognizing result; and
generating, by the at least one processor, at least one font model according to the recognizing result, wherein the personal handwriting text corresponds to one of the at least one the font model.

16. The operation method according to claim 14, wherein the plurality of feature parameters comprise at least one of a font position, a font size, a font slant, a font height and a font width.

17. The operation method according to claim 11, wherein the computer text is an alphanumeric character.

18. The operation method according to claim 11, further comprising:
generating the operation command by an input module, wherein the input module comprises at least one of a button of a keyboard, a stylus, a touch panel and a mouse.

19. (canceled)

20. (canceled)

21. The operation method according to claim 11, further comprising:
generating, by the at least one processor, writing data according to the at least one writing track of the writing text;
recognizing, by the at least one processor, the writing data to determine a text information; and
determining, by the at least one processor, the computer text according to the text information.
